(19) United States
(12) Patent Application Publication
(10) Pub. No.: US 2013/0029311 A1
(43) Pub. Date: Jan. 31, 2013

(54) SILOXANE BASED COATINGS FOR WRITABLE-ERASABLE SURFACES

(71) Applicant: IdeaPaint, Inc., Ashland, MA (US)

(72) Inventor: John Goscha, Boston, MA (US)

(73) Assignee: IDEAPAINT, INC., Ashland, MA (US)

(21) Appl. No.: 13/645,192

(22) Filed: Oct. 4, 2012

Related U.S. Application Data
(63) Continuation of application No. 13/397,461, filed on Feb. 15, 2012, now abandoned.
(60) Provisional application No. 61/443,033, filed on Feb. 15, 2011.

(51) Int. Cl. C09D 183/06; C09K 3/00; C07F 7/18; B43L 1/00; C07F 7/08

(52) U.S. Cl. 434/408; 523/435; 556/456; 556/458; 556/450; 252/182.14

(57) ABSTRACT

Siloxane-based coatings for providing writable-erasable surfaces are provided. The coatings have many desirable characteristics and advantages over known coatings for writable-erasable surfaces. For example, the coatings cure rapidly under ambient conditions, have low VOC emissions upon curing, and have reduced tendency to form ghost images, even after prolonged normal use.

### BACKGROUND

This disclosure relates to siloxane-based coatings for writable-erasable surfaces, products that include such coatings and to the methods of making and using the same.

Dry erase boards (often referred to commonly as “whiteboards”) are alternatives to traditional blackboards. Dry erase boards typically include a substrate, such as paper or board, and a coating, such as hard, non-porous coating, extending upon the substrate. The coating provides a writing surface that can be marked using dry erase marking pens. Dry erase marking pens, which are typically felt tip marking instruments, contain inks that not only can mark such surfaces, but also can be erased with minimal effort using, e.g., a dry eraser, cloth, or paper tissue.

The erasability of dry erase inks from the writing surfaces of dry erase boards can deteriorate over time, resulting in the formation of non-removable “ghost images.” In addition, such surfaces can be incompatible with some dry erase markers and can be permanently marked if inadvertently written on with a permanent marker.

### SUMMARY

This disclosure relates to siloxane-based coatings having writable-erasable surfaces, products that include such coatings (e.g., whiteboards), and to methods of making and using the same. Generally, the coatings herein provide writable-erasable surfaces on a substrate, the coatings produced from one or more precursor materials in an essentially solventless, or substantially solventless system as defined herein; and the coatings cure under ambient conditions. Optionally, the coating, once applied, cures faster and/or more completely in the presence of light, heat, and/or other types of radiation. When the writable-erasable surface is marked with a marking material, the marking material can be erased to be effectively invisible (e.g., substantially invisible) with little or no ghosting, even after prolonged and repeated use. The one or more materials that form the coatings emit minimal volatile organic compounds (VOCs) after curing on the substrate. For example, the cured coating includes less than about 100 g/L of volatile organic compounds (“VOC”). The resulting coatings have many desirable attributes, including one or more of the following: low porosity, low surface roughness, high elongation at break, high Taber abrasion resistance, and high Sward hardness. Generally, while not intending to be bound by any theory, it is believed that the low porosity of the coatings makes the coatings substantially impervious to the marking materials, while the low surface roughness prevents the marking materials from becoming entrapped on the surface beyond effective reach of an eraser. After the writable-erasable surface is marked with a marking material including a colorant and a solvent, the marking material can be erased from the writable-erasable surface to be effectively invisible (e.g., substantially invisible).

In one embodiment, a writable-erasable product includes a cured coating (such as a cross-linked coating) extending upon a substrate and having a writable-erasable surface. The coating is applied as a substantially solventless liquid composition, wherein the liquid carrier is a combination of liquid and solid starting materials, but does not require the addition of an organic solvent (such as alcohols, acetone, ketones, or other organic solvents) and further does not require addition of more than about 10% by weight of water. The applied coating composition can be cured while on a substrate under ambient conditions.

By way of non-limiting illustration, exemplary coatings and coating compositions can be formed from one or more parts each independently including one or more substances including one or more siloxanes. The at least one siloxane ingredient can optionally be provided in a solvent-based carrier. Alternatively or additionally, siloxanes herein can be provided as liquids, solids, or any combination thereof (powders, solutions, suspensions, mixtures, etc.). Some exemplary, non-limiting siloxanes appear in Table 1.

TABLE 1
Exemplary Siloxanes

| Cyclic siloxanes | Linear siloxanes |
|---|---|
| D3: hexamethylcyclotrisiloxane | MM: hexamethyldisiloxane |
| D4: octamethylcyclotetrasiloxane | MDM: octamethyltrisiloxane |
| D5: decamethylcyclopentasiloxane | MD2M: decamethyltetrasiloxane |
| D6: dodecamethylcyclohexasiloxane | MDnM: polydimethylsiloxane |

In another example, the disclosure describes a coating composition formed from one or more materials including one or more siloxanes. The exemplary formulations include at least one resin part and at least one cure part, the cure part including one or more of a siloxane.

In one example, the resin part includes one or more materials including, by weight percent: one or more of a silicone (about 15 to about 40%), an epoxy (about 10 to about 30%), a first pigment such as an oxide (about 15 to about 40%) such as titanium dioxide; and a UV absorber (about 0.5 to about 1.5%). The resin also optionally includes at least a second pigment such as an oxide that is distinct from the first oxide (about 0.5 to about 3%).

In an example, the cure part includes; one or more of a silane (60 to about 99%); a catalyst (about 3 to about 7%); and a siloxane additive part (about 0.1 to about 5%).

In other examples, such as a two-part example, the siloxane additive part can be included with the resin part as a first component part, and the cure part can be included as a second component part, the component parts being combined by a user within about 6 hours of use.

While substantially solventless systems are preferred, as previously described herein, at least one or more materials can be in a liquid carrier. The liquid carrier can be a result of mixing one or more starting materials that are present in a liquid physical state. Optionally, non-liquid starting materials can be mixed into a liquid state starting material to form either part—whether the resin part, or the cure part, or both. After the resin part and the cure part are mixed together, they form a coating composition that can be applied to the surface of a substrate to form a coating that will cure to form a writable-erasable surface. The cure part has the effect of hardening the composition, whether by cross-linking or other chemical and physical processes. After curing, the coating is hard and smooth and substantially non-porous so that it can be marked with a marking material including a colorant and a solvent, and thereafter, the marking material can be erased from the writable-erasable surface to be effectively invisible (e.g., substantially invisible). While white coatings are preferable for “white boards”, the coating can be produced in any desirable color, such as by the addition of colorants and/or pigments to the liquid state composition before curing.

In another aspect, the disclosure describes a method of making a writable-erasable product. The method includes applying the coating described herein to a substrate and curing the coating (e.g., under ambient conditions) to provide a cured coating defining a writable-erasable surface.

The coating can be formed from one or more materials or parts, each independently or collectively including one or more substances including any or all of: a resin, a silane, an epoxy, a siloxane, and optionally other ingredients such as UV absorbers, preservatives, and biocidal agents, for example. At least one of one or more of the materials can be provided in a liquid state. Optionally, one or materials is provided in a solvent carrier, preferably using water as a solvent carrier, and less preferably using an organic solvent.

In some embodiments, the composition can further optionally include additives such as a surface additive, a surfactant, a wetting agent, a defoaming agent, a pigment, and/or a colorant.

In another aspect, the disclosure describes a writable-erasable product including a cured coating extending upon a substrate and having a writable-erasable surface. The coating described herein can be applied and formed on a surface. At least one of one or more materials can be in a liquid state to act as a substantially solventless carrier. After the resulting coating cures to form, the resulting writable-erasable surface is marked with a marking material including a colorant and a solvent, the marking material can be erased from the writable-erasable surface to be effectively invisible (e.g., substantially invisible).

The one or more of the above aspects of the disclosure can include one or more of the following embodiments.

In some embodiments, the cured coating and/or the writable-erasable surface may have one or more of the following attributes. The coating may have a porosity of less than about 40 percent; a thickness of from about 0.001 inch to about 0.125 inch; a Taber abrasion value of from about 100 mg/thousand cycles to about 125 mg/thousand cycles; a Sward hardness of greater than about 10; an elongation at break of between about 5 percent and about 400 percent; a sag resistance of between about 4 mils and about 24 mils. The writable-erasable surface can be erased to be substantially invisible after writing and erasing at the same position for more than about 100 cycles, or even more than about 5,000 cycles. The writable-erasable surface can have an average surface roughness (Rₐ) of less than about 7,500 nm; a maximum surface roughness (Rₘ) of less than about 10,000 nm; a contact angle of greater than about 35 degrees; and a contact angle of less than about 150 degrees.

In some embodiments, a catalyst is included, preferably in at least one of the resin part or cure part, or both. Preferably, the catalyst is included in the cure part. In some examples, the catalyst is provided as dibutyltin dilaurate. In other examples, it is provided as triethylamine. In some examples, a UV absorber is also provided, preferably in the cure part. Sometimes, the UV absorber is provided as a sebacate, such as 1,2,2,6,6-pentamethyl-4-piperidyl sebacate (CAS 41556-26-7).

In some embodiments, where a solvent-based carrier is included, the solvent can include hydrocarbons (such as saturated hydrocarbons and unsaturated hydrocarbons), alcohols (such as alkoxy alcohols, ketonic alcohols), ketones, esters (such as acetates), mineral spirits, bio-based solvents, or mixtures thereof. Examples of such solvents can include ethyl benzene, toluene, xylene, naphtha(petroleum), petroleum distillates, n-butyl acetate, methyl iso-amyl ketone, Stoddard solvent, t-butyl acetate, acetone, isopropyl alcohol, 2-butoxyethanol, toluene, methanol, propanol, 2-butanol, iso-amyl alcohol, methyl amyl alcohol, pentane, heptane, odorless mineral spirits, methyl ethyl ketone, diacetone alcohol, methyl amyl ketone, ethyl amyl ketone, diisobutyl ketone, methyl heptyl ketone, ethyl acetate, isopropyl acetate, propyl acetate, isobutyl acetate, n-butyl acetate, glycol ether EM acetate, amyl acetate, isobutyl isobutyrate, glycol ether EE acetate, glycol ether EB acetate, 2-ethylhexyl acetate, glycol ether DE acetate, glycol DB acetate, methyl isobutyl ketone, dipropylene glycol butoxy ether, vegetable oil, corn oil, sunflower oil, or their mixtures. However, in the preferred embodiments, any such solvent comprises less than 10%, and more preferably less than 5%, and most preferably less than 1% by weight of the coating composition in its liquid state (before application to substrate and curing).

In some embodiments, the substrate can be selected from the group consisting of cellulosic material, glass, wall (such as plaster or painted wall), fiber board (e.g., a whiteboard in which the cured coating can be extending upon a fiber board), particle board (e.g., a chalkboard or blackboard), gypsum board, wood, plastics (such as high density polyethylene (HDPE), low density polyethylene (LDPE), or a acrylonitrile, butadiene, styrene (ABS)-based material), densified ceramics, stone (such as granite), and metal (such as aluminum or stainless steel). In some embodiments, the substrate can be selected from a flexible film or a rigid structure.

In some embodiments, the marking material includes a solvent including water, alcohols (such as alkoxy alcohols, ketonic alcohols), ketones, esters (such as acetates), mineral spirits, bio-based solvents, or their mixtures. In some embodiments, the marking material can be erased from the writable-erasable surface to be effectively invisible by wiping the marks with an eraser including a fibrous material (such as a paper towel, rag, or felt material). In some embodiments, the eraser is dry or includes water, alcohol (e.g., ethanol, n-propanol, isopropanol, n-butanol, isobutanol, benzyl alcohol), alkoxy alcohol (e.g., 2-(n-propoxy)ethanol, 2-(n-butoxy)ethanol, 3-(n-propoxy)ethanol), ketone (e.g., acetone, methyl ethyl ketone, methyl n-butyl ketone), ketonic alcohol (e.g., diacetone alcohol), ester (e.g., methyl succinate, methyl benzoate, ethyl propanoate), acetate (e.g., methyl acetate, ethyl acetate, n-butyl acetate, t-butyl acetate), mineral spirit, or mixtures thereof.

In some embodiments, the writable-erasable product can take the form of a whiteboard, in which the cured coating extends upon a fiberboard, can form a part of a wall e.g., of a structure, or can form a plurality of sheets, each sheet including a substrate (e.g., in the form of a paper) having the cured coating extending thereupon.

In some embodiments, prior to combining, the one or more materials including the resin part can be in a first container, and the one or more materials including one or more cure parts can be in a second container. In any embodiment, at least one siloxane additive part is provided. Preferably, the siloxane additive part is combined with the resin part prior to mixing the resin with the cure part.

Embodiments and/or aspects may include one or more of the following advantages. The coating surfaces are writable and erasable. The coatings can provide writing surfaces that exhibit little or no image ghosting, even after prolonged normal use. The coatings can be simple to prepare and can be applied to many different substrates, including both porous (e.g., paper) and non-porous substrates (e.g., densified ceramics). The coatings can be applied to various substrates including, but not limited to, chalkboards (e.g., blackboards), whiteboards, drywalls, gypsum boards, plaster, and painted walls. The solvent-based coatings can be applied on the substrate on-site rather than being manufactured in a factory. For many substrates, a single coating can provide an adequate writable-erasable surface. The coatings can exhibit good adhesive strength to many substrates. Coating components (prior to mixing) can have an extended shelf-life, e.g., up to about three years or even up to six years. The coatings can be readily resurfaced. The coatings can cure rapidly, e.g., in less than about 12 to 60 hours, and more preferably between about 24 to about 48 hours, under ambient conditions. The coatings can resist yellowing, as determined by ASTM method G-154, for an extended period of time (e.g., up to 2000 hours or even up to 5000 hours). The coatings do not require UV light or high-energy radiation, such as a beam of electrons, for curing. Nevertheless, in some embodiments, light, e.g., UV light, or heat can be utilized to enhance the curing rate. The coatings can have a reduced tendency to run even when applied upon a vertical substrate. Surface gloss of the coatings can be readily adjusted. The writing surface of the coating can be projectable. The coatings can be hard. The coatings can be substantially impervious to organic solvents and/or inks. The coatings can have a low porosity. Surfaces of the coatings can have a low roughness. The coatings can be impact resistant. The coatings can be made scratch and abrasion resistant. The coatings can be relatively low cost. The coatings can have a high chemical resistance.

“Curing” as used herein, refers to a process of setting (e.g., by evaporation (drying) or cross-linking) a material to form a coating on a substrate. Curing can be performed by exposure to ambient conditions, radiation; or cross-linking (e.g., oxidative cross-linking).

“Solvent-based” as used herein refers to a mixture predominantly containing organic solvents. Such organic solvents may be used either in their anhydrous or wet form unless specified otherwise. However, as used herein, “substantially solventless” means that any such organic solvent is present in less than about 10%, and more preferably below about 5%, and “solventless” means that any organic solvent is less than about 1% by weight/volume of the liquid coating composition before application to a substrate.

“Ambient conditions” as used herein refers to nominal, earth-bound conditions as they exist at sea level at a temperature of about 45-130° F.

“Effectively invisible” as used herein refers to a color difference Delta E (ΔE) of less than 20 as calculated according to the ASTM Test Method D2244 before and after a mark is erased by an eraser.

“Substantially invisible” as used herein refers to a color difference Delta E (ΔE) of less than 10 as calculated according to the ASTM Test Method D2244 before and after a mark is erased by an eraser.

“Alkyl” as used herein, refers to a saturated or unsaturated hydrocarbon containing 1-20 carbon atoms including both acyclic and cyclic structures (such as methyl, ethyl, propyl, isopropyl, butyl, iso-butyl, sec-butyl, pentyl, hexyl, cyclopropyl, cyclobutyl, cyclopentyl, cyclohexyl, propenyl, butenyl, cyclohexenyl, and the like). A linking divalent alkyl group is referred to as an “alkylene” (such as ethylene, propylene, and the like).

As used herein, “aryl” refers to monocyclic or polycyclic (e.g., having 2, 3, or 4 fused rings) aromatic hydrocarbons such as, phenyl, naphthyl, anthracenyl, phenanthrenyl, indanyl, indenyl, and the like. In some embodiments, aryl groups have from 6 to 20 carbon atoms, from 6 to 15 carbon atoms, or from 6 to 10 carbon atoms.

As used herein, “heteroaryl” refers to an aromatic heterocycle having at least one heteroatom ring atom such as sulfur, oxygen, or nitrogen. Heteroaryl groups include monocyclic and polycyclic (e.g., having 2, 3, or 4 fused rings) systems. Examples of heteroaryl groups include without limitation, pyridyl, furyl, quinolyl, indolyl, oxazolyl, triazolyl, tetrazolyl, and the like. In some embodiments, the heteroaryl group has from 1 to 20 carbon atoms (e.g., from 3 to 20 carbon atoms). In some embodiments, the heteroaryl group has 1 to 4 heteroatoms (e.g., 1 to 3, or 1 to 2 heteroatoms).

As used herein, “aralkyl” refers to alkyl substituted by aryl. An example aralkyl group is benzyl.

As used herein, “alkoxy” refers to an —O— alkyl group. Example alkoxy groups include methoxy, ethoxy, propoxy (e.g., n-propoxy and isopropoxy), t-butoxy, and the like.

As used herein, “oxyalkylene” refers to an —O— alkylene group. As used herein, “alkoxylate” refers to an alkyl-C(O)O. Example alkoxylates include acetate, stearate, and the like.

As used herein, “halo” includes fluoro, chloro, bromo, and iodo.

A “polyol” as used herein is a moiety that includes at least two hydroxyl (—OH) groups. The hydroxyl groups can be terminal and/or non-terminal. The hydroxyl groups can be primary hydroxyl groups.

A “polyurethane” as used herein is a polymeric or oligomeric material that includes a urethane linkage in its backbone.

As used herein, “epoxy” means an epoxy or polyepoxide polymer, including monomers or short chain polymers with an epoxide group at either end. Non-limiting exemplary expoxides are those suitable for formation from reaction of an epoxide “resin” with polyamine “hardener” or other chemical having a reactive amine group.

As used herein, a “silane” means any chemical compounds of silicon and hydrogen, which are analogues of alkane hydrocarbons. Silanes consist of a chain of silicon atoms covalently bonded to each other and to hydrogen atoms. The general formula of a silane is SiₙH₂ₙ₊₂.

As used herein, a “siloxane” means any chemical compound composed of units of the form R₂SiO, where R is a hydrogen atom or a hydrocarbon group. Such siloxanes are generally recognized to belong to the wider class of organosilicon compounds. Further, as used herein, siloxanes can have branched or unbranched backbones consisting of alternating silicon and oxygen atoms —Si—O—Si—O—, with side chains R attached to the silicon atoms. More complicated structures are also known, for example, eight silicon atoms at the corners of a cube connected by 12 oxygen atoms as the cube edges. Further, the term as used herein includes polymerized siloxanes with organic side chains (R≠H), more commonly known as silicones or as polysiloxanes. Representative examples are [SiO(CH₃)₂]ₙ (polydimethylsiloxane) and [SiO(C₆H₅)2]ₙ (polydiphenylsiloxane). These compounds are sometimes considered by those skilled in the art to be a hybrid of both organic and inorganic compounds. The organic side chains confer hydrophobic properties while the —Si—O—Si—O— backbone is purely inorganic.

All publications, patent applications, patents, and other references mentioned herein are hereby incorporated by reference herein in their entirety.

It is to be further appreciated that certain features of the invention, which are, for clarity, described in the context of separate embodiments, can also be provided in combination in a single embodiment. Conversely, various features of the invention which are, for brevity, described in the context of a single embodiment can also be provided separately or in any suitable subcombination.

The details of one or more embodiments of the disclosure are set forth in the accompanying drawings and in the description below. Other features and advantages will be apparent from the description and drawings, and from the claims.

### BRIEF DESCRIPTION OF THE DRAWINGS

FIG. 1 is a top view of a writable-erasable product.

FIG. 1A is a cross-sectional view of the writable-erasable product of FIG. 1, along 1A-1A.

Like reference symbols in various drawings indicate like elements.

### DETAILED DESCRIPTION

### Writable-Erasable Product

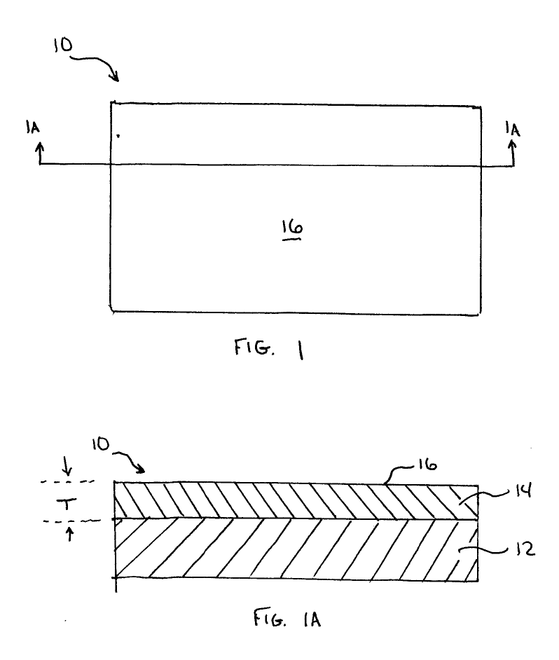

Referring to FIGS. 1 and 1A, a writable-erasable product 10 includes a substrate 12 and a coating 14 (e.g., a cured coating) extending upon the substrate 12. The cured coating 14 has a writable-erasable surface 16. When the writable-erasable surface 16 is marked with a marking material, the marking material can be erased from the writable-erasable surface to be effectively (e.g., substantially) invisible, resulting in little or no ghosting, even after prolonged normal use, for example, after about 10 cycles (e.g., after about 50 cycles, after about 100 cycles, after about 500 cycles, after about 1,000 cycles, after about 2,000 cycles, after about 3,000 cycles, after about 4,000 cycles, after about 5,000 cycles, after about 6,000 cycles, after about 7,000 cycles, after about 8,000 cycles, or after about 9,000 cycles) of writing and erasing at the same position. The visibility, or the lack thereof, of the erasing can be determined by measuring the color change (Delta E, ΔE) on the writable-erasable surface using a spectrophotometer (such as the SP-62 portable spectrophotometer available from X-Rite), after marking on the surface and erasing the marking. The color change is a composite of three variables, lightness (L*), red/green value (a*), and yellow/blue value (b*). The erasability characteristics of the writable erasable surface 16 can be defined in terms of the ΔE value. In some embodiments, the ΔE for the writable-erasable surface 16 after 5,000 cycles (or even after 10,000 cycles) can be less than about 50, e.g., less than about 40, less than about 30, less than about 20, less than about 10, less than about 9, less than about 8, less than about 7, less than about 6, less than about 5, less than about 4, less than about 3, less than about 2, or less than about 1.

In some embodiments, the ΔE for the writable-erasable surface 16 after 5,000 cycles (or even after 10,000 cycles) can be from about 0.1 to about 10.0, e.g., from about 0.1 to about 0.5, from about 0.5 to about 1.0, from about 1.0 to about 1.5, from about 1.5 to about 2.0, from about 2.0 to about 2.5, from about 2.5 to about 3.0, from about 3.0 to about 3.5, from about 3.5 to about 4.0, from about 4.0 to about 4.5, from about 4.5 to about 5.0, from about 5.0 to about 5.5, from about 5.5 to about 6.0, from about 6.0 to about 6.5, from about 6.5 to about 7.0, from about 7.0 to about 7.5, from about 7.5 to about 8.0, from about 8.0 to about 8.5, from about 8.5 to about 9.0, from about 9.0 to about 9.5, or from about 9.5 to about 10.0.

It is to be appreciated that the erasability characteristic may also be evaluated based on the differences in L* (ΔL*), without attribution to color differences. This evaluation can also be combined with the progressive abrasion of the coating on an abrader, such as the Taber abrader 4360. The abrasion of the coating can be performed similar to the ASTM Method D4060. In this instance, the erasability characteristic as a function of the abrasion can be determined by abrading the writable-erasable surface 16 for a certain number of cycles and then measuring the change in lightness (ΔL*) value after marking on the surface followed by erasing the marking. Typically, a substrate with a cured coating can be loaded on an abrader and abrasive wheels can be rotated on the writable-erasable surface 16 for a certain number of cycles (e.g., 50 cycles, 100 cycles, 150 cycles, 200 cycles, 500 cycles, or 1,000 cycles). After each abrasive cycle, a spectrophotometer (such as the SP-62 portable spectrophotometer available from X-Rite) can be used to measure the L* of the abraded area (L*ₐ) and the writable-erasable surface 16 can be marked with a marking material (such as an Expo® 1 or Expo® 2, blue or black marker) and erased (such as with an Expo® felt dry eraser). A spectrophotometer (such as the SP-62 portable spectrophotometer available from X-Rite) can be used to measure the L* value of the erased area (L*_{b}). The ΔL* can be determined from the difference of L*ₐ and L*_{b} values. In some embodiments, the ΔL* value for the writable-erasable surface 16 after 1,000 cycles can be at least about 20, e.g., at least about 30, at least about 40, at least about 50, at least about 60, at least about 65, at least about 70, at least about 75, at least about 80, at least about 85, at least about 90, or at least about 99. In some other embodiments, the ΔL* value for the writable-erasable surface 16 after 1,000 cycles can be at least about 65, e.g., at least about 67, at least about 69, at least about 71, at least about 73, at least about 75, at least about 77, at least about 79, at least about 81, at least about 83, at least about 85, at least about 87, at least about 89, or at least about 91. In yet other embodiments, the ΔL* value for the writable-erasable surface 16 after 1,000 cycles can be from about 65 to about 70, from about 70 to about 75, from about 75 to about 80, from about 80 to about 85, from about 85 to about 90, from about 90 to about 95, or from about 95 to about 99.

The marking material can include a colorant (e.g., a pigment) and a solvent such as water, alcohol (such as alkoxy alcohol, ketonic alcohol), ketone, ester (such as acetate), mineral spirit, bio-based solvents (e.g., vegetable oil, corn oil, sunflower oil), or mixtures thereof. Bio-based solvents are alternatives to conventional organic solvents and can be obtained from agricultural products. Such solvents can provide lower volatile organic compounds in coatings and decreased environmental impact. The marking material can be selected from any of the industry standard dry-erase markers.

The materials that form the coating 14 can be applied to many different types of substrates, including porous (e.g., paper) and non-porous substrates (e.g., densified ceramics). The substrate 12 can be a flexible film or a rigid movable or immovable structure. Examples of the substrate include, but not limited to, a polymeric material (such as a polyester or a polyamide), a cellulosic material (such as paper), glass, wood, plastics (such as HDPE, LDPE, or an ABS-based material), a wall (such as a plaster or painted wall), a fiber board (such as a whiteboard in which the cured coating extends upon a fiber board), a particle board, (such as a chalkboard or blackboard), a gypsum board, densified ceramics, stone (such as granite), and a metal (such as aluminum or stainless steel). The substrate could be a newly built structure or even an old and worn out chalkboard, blackboard, or whiteboard. In some instances, the surface of the substrate can be cleaned by sanding the surface and priming the surface prior to application of the coating. In some instances, the surface can also be cleaned with a cleaning agent (e.g., acetone or a mild acid) in order to provide better adhesion of the coating to the surface.

The materials that form the coating 14, prior to the application on substrates, can have a pot life which is the period during which the materials must be applied on the substrate. In some embodiments, the materials can have a pot life of from about 10 minutes to about 16 hours, for example, from about 30 minutes to about 12 hours, from about 60 minutes to about 8 hours, from about 2 hours to about 4 hours, or from about 1 hour to about 4 hours, or from about 1 hour to about 2 hours. In other embodiments, the materials can have a pot life of greater than about 6 months, for example, about 12 months, about 18 months, about 24 months, about 30 months, or about 36 months. In the embodiments herein that are substantially solventless, the pot life of the composition after mixing the resin part and any cure part(s) is preferably between about 4 to about 6 hours.

The materials that form the coating 14, upon application to the substrate(s), typically cure under ambient conditions. While not intending to be bound by any theory, it is believed that cross-linking between polymeric chains can influence certain unique properties of coatings. In some optional embodiments, the curing can be facilitated by ultra-violet (UV) light, thermal means, initiators, electron-beams, and combinations thereof. The coating 14 on the substrate 10 can cure under ambient conditions in from about 4 hours to about a week, e.g., from about 4 hours to about 24 hours, from about 8 hours to about 20 hours, from about 12 hours to about 16 hours, from about 1 day to about 7 days, from about 2 days to about 6 days, or from about 3 days to about 5 days. The cured coating 14 can be generally stable and also emit little or no VOCs after curing. Curing under ambient conditions can reduce environmental impact and can make the materials safer to use.

The porosity of a coating can determine the amount of marking material that can be trapped in the coating. While not intending to be bound by any theory, it is believed that lower porosity of coatings can lead to better writable-erasable surfaces. In some embodiments, the coating 14 can have a porosity of between about 1 percent and about 40 percent, e.g., between about 2 percent and about 35 percent, between about 2.5 percent and about 30 percent, or between about 3 percent and about 20 percent. In other embodiments, the coating 14 can have a porosity of less than about 40 percent, e.g., less than about 35 percent, less than about 30 percent, less than about 25 percent, less than about 20 percent, less than about 15 percent, less than about 10 percent, less than about 5 percent, or even less than about 2.5 percent.

In some embodiments, the coating can have a porosity of between about 2 percent and about 45 percent, e.g., between about 2.5 percent and about 35 percent, or between about 3 percent and about 35 percent. In some specific embodiments, the coating can have a porosity of about 3 percent, about 33 percent, or about 34 percent.

The coating formulations can be prepared by standard techniques known to one skilled in the art. For example, during a grind stage, pre-determined amounts of the materials to be used in the formulation can be mixed at required speeds in high shear dispersers until the materials are homogeneously dispersed. The degree of dispersion of the materials and pigments can be determined with a Hegman gauge. The remaining materials, if any, can be introduced at a letdown stage to obtain the final formulation before being packaged. In two-component coating formulations, the two parts are mixed thoroughly and can be allowed to stand for a period of time before it can be applied on a substrate.

The coating formulation can be applied on a substrate 12 in a single coat or multiple coats using a roller, a spray (such as an aerosol spray), a brush, or using other types of applicators. In some embodiments, it can be painted using a foam roller in a single coat. In some embodiments, the coating 14 can have a thickness, T (FIG. 1A), e.g., between about 0.001 inch and about 0.125 inch, e.g., between about 0.002 inch and about 0.1 inch, between about 0.004 inch and about 0.08 inch, between about 0.006 inch and about 0.06 inch, between about 0.008 inch and about 0.04 inch, or between about 0.01 inch and about 0.02 inch). In other embodiments, the coating 14 can have a thickness of greater than about 0.005 inch, e.g., greater than about 0.0075 inch or greater than about 0.010 inch. While not intending to be bound by any theory, it is believed that providing a uniform, adequate coating thickness, T, reduces the likelihood of thin or uncoated substrate portions where marking materials might penetrate.

In some embodiments, the coating 14 can have a Taber abrasion value of less than about 150 mg/thousand cycles, e.g., less than about 100 mg/thousand cycles, less than about 75 mg/thousand cycles, less than about 50 mg/thousand cycles, less than about 35 mg/thousand cycles, less than about 25 mg/thousand cycles, less than about 15 mg/thousand cycles, less than about 10 mg/thousand cycles, less than about 5 mg/thousand cycles, less than about 2.5 mg/thousand cycles, less than about 1 mg/thousand cycles, or even less than about 0.5 mg/thousand cycles. Maintaining a low Taber abrasion value can provide long-lasting durability to the coating, reducing the incidence of thin spots which could allow penetration of marking material through the coating and into the substrate.

In some embodiments, the coating 14 can have a Sward hardness of greater than about 10, e.g., greater than about 15, greater than about 25, greater than about 50, greater than about 75, greater than about 100, greater than about 120, greater than about 150, or even greater than about 200. While not intending to be bound by theory, it is believed that maintaining a high Sward hardness provides long-lasting durability and scratch resistance to the coating. Marking material entrapped in scratches can be difficult to erase.

In some specific embodiments, the coating 14 can have a Sward hardness of between about 10 and about 75, e.g., between about 15 and about 70 or between about 15 and about 55. In some specific embodiments, the coating can have a Sward hardness of about 15, about 22 or about 25.

In some embodiments, elongation at break for the coating material can be between about 5 percent and about 400 percent, e.g., between about 25 percent and about 200 percent, or between about 50 percent and about 150 percent. In other embodiments, the elongation at break can be greater than about 10 percent, e.g., greater than about 25 percent, greater than about 50 percent, or even greater than about 100 percent. While not intending to be bound by theory, it is believed that maintaining high elongation at break provides long-lasting durability to the coating and it allows the coating to be stressed without forming cracks. Cracks can trap marking materials making erasure from surfaces difficult and, hence, decreasing the longevity of the writable-erasable products.

In some embodiments, the sag resistance for the coating material can be at least about 3 mils, e.g., about 4 mils, about 5 mils, about 6 mils, about 7 mils, about 8 mils, about 9 mils, about 10 mils, about 12 mils, about 14 mils, about 16 mils, about 18 mils, about 20 mils, about 22 mils, or about 24 mils. In other embodiments, the coating 14 can have a sag resistance of from about 4 mils to about 24 mils, e.g., from about 5 mils to about 20 mils, from about 6 mils to about 18 mils, from about 7 mils to about 16 mils, from about 8 mils to about 14 mils, from about 9 mils to about 12 mils, or from about 10 mils to about 12 mils.

In some embodiments, the writable-erasable surface 16 can have an average surface roughness (Rₐ) of between about 0.5 nm and about 7,500 nm, e.g., between about 1 nm and about 6,000 nm, between about 2 nm and about 5,000 nm, between about 5 nm and about 2,500 nm, between about 10 nm and about 1,500 nm, between about 20 nm and about 1,000 nm or between about 25 nm and about 750 nm. In other embodiments, the writable-erasable surface 16 can have an average surface roughness (Rₐ) of less than about 7,500 nm, e.g., less than about 5,000 nm, less than about 3,000 nm, less than about 2,000 nm, less than about 1,000 nm, less than about 500 nm, less than about 250 nm, less than about 200 nm, less than about 100 nm, or even less than about 50 nm.

In some specific embodiments, the writable-erasable surface 16 can have an average surface roughness (Rₐ) of between about 75 nm and about 1,000 nm, e.g., between about 100 nm and about 500 nm or between about 150 nm and about 400 nm. In some specific embodiments, the writable-erasable surface 16 can have an average surface roughness (Rₐ) of about 150 nm, about 300 nm, or about 1,000 nm. In some embodiments, the writable-erasable surface 16 can have a maximum surface roughness (Rₘ) of less than about 10,000 nm, e.g., less than about 8,000 nm, less than about 6,500 nm, less than about 5,000 nm, less than about 3,500 nm, less than about 2,000 nm, less than about 1,000 nm, or less even than about 500 nm.

In some embodiments, the writable-erasable surface 16 can have a flat finish (gloss below 15, measured at 85 degrees), an eggshell finish (gloss between about 5 and about 20, measured at 60 degrees), a satin finish (gloss between about 15 and about 35, measured at 60 degrees), a semi-gloss finish (gloss between about 30 and about 65, measured at 60 degrees), or gloss finish (gloss greater than about 65, measured at 60 degrees).

In some specific embodiments, the writable-erasable surface 16 can have a 60 degree gloss of between about 45 and about 90, e.g., between about 50 and about 85. In other embodiments, the writable-erasable surface 16 can have a 20 degree gloss of between about 10 and about 50, e.g., between about 20 and about 45. In still other embodiments, the writable-erasable surface 16 can have a 85 degree gloss of between about 45 and about 90, e.g., between about 75 and about 90. In other specific embodiments, the writable-erasable surface 16 can have a 20 degree gloss of about 12, about 23, or about 46; or a 60 degree gloss of about 52, about 66, or about 85; or a 85 degree gloss of about 64, about 78, or about 88.

In some embodiments, to improve the writability and erasability of the surface 16 of the coating 14, precursor materials can be chosen so that the cured coating 14 has a surface that is relatively hydrophilic and not very hydrophobic. Referring to FIG. 1A, hydrophobicity of the writable-erasable surface 16 is related to its wettability by a liquid, e.g., a water-based marking material. It is often desirable to quantify the hydrophobicity of the writable-erasable surface 16 by a contact angle. Generally, as described in ASTM D 5946-04, to measure contact angle, θ, for a liquid (such as water) on the writable-erasable surface 16, an angle is measured between the writable-erasable surface 16, and a tangent line 26 drawn to a droplet surface of the liquid at a three-phase point. Mathematically, θ is 2× arctan(A/r), where A is the height of the droplet image, and r is half width at the base. In some embodiments, it can be desirable for the writable-erasable surface 16 to have contact angle, θ, measured using deionized water of less than about 150 degrees e.g., less than about 125 degrees, less than about 100 degrees, less than about 75 degrees, or even less than about 50 degrees. In other embodiments, it can be desirable for the writable-erasable surface 16 to have contact angle θ above about 35 degrees, e.g., above about 40 degrees, or above about 45 degrees.

In certain embodiments, contact angle, θ, measured using deionized water, can be between about 30 degrees and about 90 degrees, e.g., between about 45 degrees and about 80 degrees, or between about 39 degrees and about 77 degrees. In some specific embodiments, the contact angle can be about 40 degrees, for example, about 50 degrees, about 60 degrees, about 73 degrees, or about 77 degrees.

In some embodiments, the writable-erasable surface 16 can have a surface tension of between about 30 dynes/cm and about 60 dynes/cm, e.g., between about 40 dynes/cm and about 60 dynes/cm. In some specific embodiments, the writable-erasable surface 16 can have a surface tension of about 25 dynes/cm, about 30 dynes/cm, about 42 dynes/cm, about 44 dynes/cm, or about 56 dynes/cm.

In general, the coating 14 can be formed by applying (e.g., rolling, painting, or spraying) a solution of the material in a solvent-based carrier that can have a sufficient viscosity such that the applied coating 14 does not run soon after it is applied or during its curing. At the same time, the solution viscosity should be sufficient to permit easy application. In some embodiments, the applied solution can have a viscosity at 25° C. of between about 75 mPas and about 20,000 mPas, e.g., between about 200 mPas and about 15,000 mPas, between about 1,000 mPas and about 10,000 mPas, or between about 750 mPas and about 5,000 mPas.

Advantageously, when the writable-erasable surface 16 is marked with a marking material that includes a colorant and a solvent, the marking material can be erased from the writable-erasable surface to be effectively (e.g., substantially) invisible. The solvent includes one or more of water, alcohols (such as alkoxy alcohols, ketonic alcohols), ketones, esters (such as acetates), mineral spirits, or bio-based solvents (e.g., vegetable oil, corn oil, or sunflower oil). Mixtures of any of the noted solvents can also be used. For example, mixtures of two, three, four or more of the noted solvents may be used.

In some embodiments, the marking material can be erased from the writable-erasable surface 16 to be effectively (e.g., substantially) invisible by wiping the marks with an eraser that includes a fibrous material. For example, the eraser can be in the form of a disposable wipe, a cloth, or a supported (e.g., wood, plastic) felt. The eraser can also include a solvent such as water, alcohols (e.g., alkoxy alcohols, ketonic alcohols), ketones, esters, (e.g., acetates), or mineral spirits. Mixtures of any two or more of these solvents can also be used.

Examples of alcohols that can be used in the marking material or the eraser include ethanol, n-propanol, iso-propanol, n-butanol, iso-butanol, benzyl alcohol, 2-(n-propoxy)ethanol, 2-(n-butoxy)ethanol and 3-(n-propoxy)ethanol. Examples of ketones that can be used in the marking material or the eraser include acetone, methyl ethyl ketone and methyl n-butyl ketone. Examples of esters that can be used in the marking material or the eraser include methyl acetate, ethyl acetate, n-butyl acetate, and t-butyl acetate.

For testing, the coating 14 can be made by casting a material on a fluoropolymer substrate and then curing the material so that it can have a dry thickness of about 0.002 inch. The cured sample can then be removed from the fluoropolymer substrate to provide the test specimen. Testing can be performed at 25° C. Elongation at break can be measured using ASTM method D-882; porosity can be measured using mercury porosimetry (suitable instruments available from Micromeritics, Norcross, Ga., e.g., Micromeritics Autopore IV 9500); surface roughness can be measured using atomic force microscopy (AFM) in tapping mode using ASME B46.1 (suitable instruments, e.g., WYKO NT8000, are available from Park Scientific); Taber abrasion resistance can be measured according to ASTM method D-4060 (wheel CS-17, 1 kg load) and Sward hardness can be measured according to ASTM method D-2134 (Sward Hardness Rocker Model C). The amount of VOCs can be determined using the EPA Method 24. Gloss can be measured using ASTM method D-523-89 (BYK Tri-Gloss Meter Cat. No. 4525). Contact angle can be measured with deionized water using the dynamic contact angle method (Angstroms Model FTA 200) using ASTM method D-5946-04. Sag resistance can be measured using ASTM method D4400 which can be performed by obtaining a draw-down and measuring visually by comparison with standard ASTM pictures. Surface tension can be measured using AccuDyne Marking Pens. Stormer Viscosity can be measured on a Brookfield Viscometer by ASTM method D-562 and reported in Kreb units (Ku).

Any writable-erasable product described herein can have any one or more of any of the attributes described herein. For example, the writable-erasable surface can have an average surface roughness (Rₐ) of less than about 7,500 nm, a maximum surface roughness (Rₘ) of less than about 7,500 nm, a 60 degree gloss of less than about 50 and a contact angle of less than about 100 degrees.

Any coatings described herein can have any one or more of any of the following attributes. For example, the coating can have a porosity of less than about 45 percent, an elongation at break of between about 25 percent and about 200 percent, and/or a Sward hardness of greater than about 3, and a Taber abrasion value of less than about 150 mg/thousand cycles.

### Formulations

The cured coating 14 having the writable-erasable surface 16 can be formed under ambient conditions from an uncured coating formulation. The coating formulations, in general, can include the materials described below. The formulations can include either a one-component system or a multi-component system (e.g., a two-component system). Preferably, in any embodiment, the coating composition and/or its parts will not cure if denied light and sealed in a substantially air-free container. A one-component system, for example, consists of a coating formulation material packaged to be ready for use. A two-component system, for example, consists of two coating materials that are mixed, upon demand and when desired, to obtain the final liquid coating formulation prior to application on the substrate.

### Epoxies

A silane-based epoxy coating formulation can be obtained by mixing an epoxy resin with at least one siloxane (silicone, for example), and thereafter adding at least a cure part. The silane-based epoxy resins can include polyether chains that contain one or more epoxide units in their structure. Polyethers have the repeating oxyalkylene units: alkylene substituted by oxygen groups, e.g., ethyleneoxy (—[CH₂—CH₂O]—). In some embodiments, the polyether chains can have additional functional groups such as hydroxyl (—OH). Curing of epoxy resins can lead to less amount of volatile products. Due to the unique properties of the epoxide ring structure, the curing agents in the cure part can be either nucleophilic or electrophilic. Examples of nucleophilic agents include alcohols, phenols, amines, amino silanes, thiols, carboxylic acids, and acid anhydrides. Examples of electrophilic agents include aryl iodonium salts, aryl sulfonium salts, and latent acid catalysts (e.g., dibutyltin diacetatonate CAS 22673-19-4, aka 4-pentanedionato-o,o ′)-dibutyl bis(oc-6-11)-ti; dibutyl bis(2,4-pentanedionato-,o′)-, (oc-6-11)-tin; di-n-butyltin bis(acetylacetonate), tech., 95%; di-n-butyltin bis(acetylacetonate); di-n-butyltin bis(2,4-pentanedionate); di-n-butyl bis(2,4-pentanedionate)tin; dibutyltin bis(acetylacetonate); dibutyltin bis(2,4-pentanedionate); dibutyl bis(pentane-2,4-dionato-o,o′)tin; tin, dibutyl bis(2,4-pentanedionato-.kappa.o,.kappa.o)-, (oc-6-11)-; sn(acac)bu2; dibutyl bis(pentan-2,4-dionato-o,o′)zinn; bis-(2,4-pentanedionato)-dibutyltin; dibutyl bis(2,4-pentanedionato-o,o″)-; di-n-butyltin bis(acetylacetonate), tech.; dibutyltin bis(2,4-pentanedionate), typically 95%; einecs 245-152-0; tin, dibutyl bis(2,4-pentanedionato-o,o′)-, (oc-6-11)-, (molecular formula=C₁₈H₃₂O₄Sn)). In some embodiments, these curing agents can contain one or more nucleophilic groups. The epoxy resins themselves can contain an aliphatic (such as cyclic or acyclic) or an aromatic backbone or a combination of both. In some optional embodiments, the epoxy resins can contain other non-interfering chemical linkages (such as alkyl chains).

For example, the coating 14 described in FIG. 1 can be formed from a resin part that includes an epoxy material, a silicon, and a first oxide. The epoxy material preferably includes at least one epoxy-modified polysiloxane polymer. Exemplary epoxy-modified polymers can be obtained by taking an epoxide resin having more than one 1,2-epoxy groups per molecule with an epoxide equivalent weight in the range of from 100 to about 2,000 that undergoes chain extension by reaction with the amine groups in the polysiloxane. Such polymers and processes are described in U.S. Pat. No. 5,618,860, which is incorporated herein by reference.

The resin part is then mixed with a cure part, the cure part including a silane base, a catalyst, and a siloxane additive part. Either or both of the two parts or components can be in a solvent-based carrier. In such embodiments, the epoxy material can serve as a crosslinking material. In some embodiments, an accelerator is included be added to the mixed components to serve as an accelerator to accelerate the reaction between the two parts and their components. In some specific embodiments, the epoxide material can be epichlorohydrin, glycidyl ether type (such as diglycidyl ether of bisphenol-A), oxirane modified fatty acid ester type, or oxirane modified ester type.

### Hybrid Systems

Some or all of the formulation systems mentioned above may be combined together in a substantially solventless hybrid system. A hybrid system typically is an admixture of two types of resins. The hybrid system can either be a hybrid polymer system in a homogeneous medium or a hybrid polymer system in a non-homogeneous medium (e.g., a hybrid dispersion). Hybrid systems can contain two classes of different polymers or resins which interact cooperatively to provide desired properties, possibly in a solvent-based carrier. In some embodiments, the hybrid material in a solvent-based carrier can be part of a one-component or a two-component coating material.

The coating 14 can be formed from a material in a liquid carrier. Preferably, the liquid carrier includes less than about 10%, and more preferably less than about 5%, and most preferably less than about 1% by volume/weight of any solvent-based carrier, e.g., an organic solvent. While not intending to be bound by theory, it is believed that some solvents whether organic or water-based) can be effective as a dispersive vehicle for the pigments and resins in a coating formulation prior to curing. For example, during the application of the formulation, they can aid in achieving an appropriate viscosity of the formulation. However, after the coating has been cured, it can be expected that there is no residual solvent. Exemplary solvents, when optionally present, can include 2-butoxyethanol, ethylene glycol, ethyl benzene, xylenes, methyl amyl ketone, isopropyl alcohol, propylene glycol monomethyl ether, ethylene glycol monobutyl ether, butanol, paraffins, alkanes, polypropylene glycol, Stoddard solvent, toluene, ethoxylated alkylphenol, 1-methyl-2-pyrrolidinone, or 1-ethylpyrrolidin-2-one. In some embodiments, the solvent can be or includes hydrocarbons (such as saturated hydrocarbons and unsaturated hydrocarbons), alcohols (such as alkoxy alcohols, ketonic alcohols), ketones, esters (such as acetates), glycol ethers, and glycol ether esters. Examples of hydrocarbons include toluene, xylene, naphtha(petroleum), petroleum distillates, ethyl benzene, trimethyl benzenes, and fractions of hydrocarbon mixtures obtained from petroleum refineries. Mixtures of any two or more of these solvents may also be utilized. Examples of alcohols include ethanol, n-propanol, iso-propanol, n-butanol, iso-butanol, benzyl alcohol, 2-(n-propoxy)ethanol, 2-(n-butoxy)ethanol, 3-(n-propoxy)ethanol, and 2-phenoxyethanol. Mixtures of any two or more of these solvents may also be utilized.

Examples of ketones include acetone, methyl ethyl ketone, methyl n-propyl ketone, methyl n-butyl ketone, and methyl isoamyl ketone. Mixtures of any two or more of these solvents may also be utilized.

Examples of esters include ethyl propanoate, ethyl butanoate, ethyl glycolate, propyl glycolate, butyl glycolate, and isoamyl glycolate, methyl acetate, ethyl acetate, n-butyl acetate, isoamyl acetate, and t-butyl acetate. Mixtures of any two or more of these solvents may also be utilized.

### Other Modifying Agents in the Formulations

Accelerators are agents that speed up the curing process. Exemplary accelerators that can be used in the formulation include dibutyltin dialkanoate (e.g., dibutyltin dialaurate, dibutyltin dioctoate), and oxazolidine. Acid promoters are also optional agents that speed up the curing process. Acid promoters include aryl, alkyl, and aralkyl sulfonic acids; aryl, alkyl, and aralkyl phosphoric and phosphonic acids; aryl, alkyl, and aralkyl acid pyrophosphates; carboxylic acids; sulfonimides; mineral acids and mixtures thereof. Examples of sulfonic acids include benzenesulfonic acid, para-toluenesulfonic acid, dodecylbenzenesulfonic acid, and naphthalenesulfonic acid. Examples of aryl, alkyl, and aralkyl phosphates and pyrophosphates include phenyl, para-tolyl, methyl ethyl, benzyl, diphenyl, di-para-tolyl, di-methyl, di-ethyl, di-benzyl, phenyl-para-tolyl, methyl-ethyl, phenyl-benzyl phosphates and pyrophosphates. Examples of carboxylic acids include citric acid, benzoic acid, formic acid, acetic acid, propionic acid, butyric acid, dicarboxylic acids such as oxalic acid, and fluorinated acids such as trifluoroacetic acid. Examples of sulfonimides include dibenzene sulfonimide, di-para-toluene sulfonimide, methyl-para-toluene sulfonimide, and dimethyl sulfonamide. Examples of mineral acids include phosphoric acid, nitric acid, sulfuric acid and hydrochloric acid. In some embodiments, phosphoric acid, citric acid or a combination thereof can be utilized as an acid promoter.

Surface additives can modify the surface characteristics (such as surface tension properties, substrate wetting, gloss, feel, and slip) of the writable-erasable surface 16. Examples of surface additives can include modified polydimethyl siloxanes and polytetrafluoroethylene. The curable compositions can also contain other optional ingredients such as fillers, surfactants, light stabilizers, pigments, opacifying agents, defoaming agent, surface gloss-modifying agent, biocides, viscosity-modifying agent, dispersing agents, reactive diluents, extender pigments, inhibitors for corrosion or efflorescence, flame retardants, intumescent agents, thermal agents for energy efficiency, additives for protection from UV and/or IR, self-cleaning agents, perfumes, or odor sustaining agents.

Several commercial suitable light stabilizers are available from CIBA Specialty Chemicals under the trade names TINUVIN® (benzotriazole, triazine, or hindered amine based) and CHIMASSORB® (benzophenone based).

Wetting agents can modify the viscosity characteristics of the coating formulations. Examples of wetting agents can include silicone free family of agents, Metolat® available from Munzing Chemie GmbH.

Examples of opacifying agents can include zinc oxide, titanium dioxide, silicon dioxide, Kaolin clay, e.g., high whiteness Kaolin clay, or mixtures thereof.

Defoaming agents can release the trapped air in the coatings and can enhance the surface smoothness. Examples of defoaming agents can include polyethylene glycols, or silicone surfactants, e.g., polyether modified polydimethyl siloxane. Defoaming agents such as the BYK family of agents are available from BYK-Chemie GmbH.

Examples of viscosity modifying agents include polyurethanes, or a commercial acrylic copolymer, TAFIGEL®, available from Munzing Chemie GmbH.

Certain embodiments are further described in the following examples which are not intended to limit the scope of the disclosure.

### EXAMPLES

### Example 1

In a first exemplary embodiment, a formulation for application to a substrate is provided. Upon application, and followed by a curing period, a cured coating is formed. Preferably, the cure is at ambient conditions and temperatures and less than about 48 hours in curing time to useful hardness. The pot life after mixing the resin and the cure part is preferably at least about 4 hours and sometimes as long as about 6 hours. In this example, the formulation includes two parts: a resin part and a cure part.

### A. Exemplary Resin Part:

A1. Silicone base=about 15-40% by weight. An exemplary suitable silicone base includes those commercially available from reputable DuPont, Akzo Nobel, PPG, et al. Further, as described in U.S. Pat. No. 5,618,860, the silicone base may include a polysiloxane. With respect to the polysiloxane used to make up the resin component, preferred polysiloxanes include, but are not limited to, those having the formulae described in U.S. Pat. No. 5,618,860, such as,

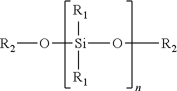

wherein each R₁ is selected from the group consisting of the hydroxy group and alkyl, aryl, and alkoxy groups having up to six carbon atoms. Each R₂ is selected from the group consisting of hydrogen and alkyl and aryl groups having up to six carbon atoms. It is preferred that each R₁ and R₂ comprise groups having less than six carbon atoms to facilitate rapid hydrolysis of the polysiloxane, which reaction is driven by the volatility of the alcohol analog product of the hydrolysis. R₁ and R₂ groups having greater than six carbon atoms tend to impair the hydrolysis of the polysiloxane due to the relatively low volatility of each alcohol analog. Methoxy, ethoxy, and silanol functional polysiloxanes having n selected molecular weights are about 400 to about 2000 which are preferred. Methoxy, ethoxy, and silanol functional polysiloxanes having molecular weights of less than 400 would produce a coating composition that would be brittle and offer poor impact resistance. Methoxy, ethoxy, and silanol functional polysiloxanes having molecular weights of greater than 2000 produce a coating composition having both a viscosity outside the desired range of from about 3,000 to 15,000 centipoise (cP) at 20° C. and are too viscous for application without adding solvent in excess of current volatile organic content (VOC) requirements. Especially preferred methoxy functional polysiloxanes are: DC-3074 and DC-3037 from Dow Corning; and GE SR191 and SY-550 from Wacker located in Adrian, Mich. Silanol functional polysiloxanes include, but are not limited to, Dow Corning's DC840, Z6018, Q1-2530, and 6-2230 intermediates. A preferred silicone base composition comprises in the range of from 15 to 45 percent by weight polysiloxane. A preferred composition comprises in the range of from one to ten percent by weight polysiloxane. If the coating composition comprises an amount of polysiloxane outside each range, the coating composition produced will display chemical resistance. A particularly preferred coating composition comprises approximately 30 percent by weight polysiloxane. The preferred composition comprises approximately 3 percent by weight polysiloxane. With respect to organooxysilane used to make up the resin component, preferred organooxysilanes have the general formulae described in U.S. Pat. No. 5,618,860, wherein R₃ is selected from the group consisting of alkyl and cycloalkyl groups containing up to six carbon atoms and aryl groups containing up to ten carbon atoms. R₄ is independently selected from the group consisting of alkyl, hydroxyalkyl, alkoxyalkyl and hydroxyalkoxyalkyl groups containing up to six carbon atoms. It is preferred that R₄ comprise groups having up to six carbon atoms to facilitate rapid hydrolysis of the organooxysilane, which reaction is driven by the evaporation of the alcohol analog product of the hydrolysis. R₄ groups having greater than six carbon atoms tend to impair the hydrolysis of the organooxysilane due to the relatively low volatility of each alcohol analog. Particularly preferred organooxysilanes are trialkoxysilanes such as Union Carbide's A-163 (methyl trimethoxy silane), A-162 and A-137, and Dow Corning's Z6070 and Z6124. A preferred coating composition comprises in the range of from one to ten percent by weight organooxysilane. A preferred composition comprises up to about two percent by weight organooxysilane. If the coating composition comprises an amount of organooxysilane outside each range, the coating composition produced will display inferior impact resistance and chemical resistance. A particularly preferred coating composition comprises approximately five percent by weight organooxysilane. The preferred composition comprises approximately 0.7 percent by weight organooxysilane.

A2. Titanium dioxide CAS 13463-67-7=15-40% by weight.

A3. Epoxy base=about 10-30% by weight. An exemplary suitable epoxy includes that commercially available from companies such as DuPont, Akzo Nobel, or PPG. For example, epoxy resins in substantially solventless, or alternatively, in a solvent-based carrier may be utilized. Epoxy bases including at least one epoxy-modified polysiloxane are preferred. Such epoxy bases include those listed in U.S. Pat. No. 5,618,860. For example, preferred epoxide resins are blends of Shell Epon 828 (bisphenol A-epichlorohydrin epoxy resin) with difunctional epoxide reactive diluents such as neopentylglycol diglycidylether, resorcinol diglycidyletherandcyclohexanedimethanoldiglycidylether, bisphenol F epoxy resins i.e., Shell Epon DPL 862 (bisphenol F-epiclorohydrin epoxy resin) and epoxy phenol novalac resins such as: Epalloy 8250 (epoxy novalac resin) from CVC located in Cherry Hill, N.J.; Araldite EPN 1139 from Ciba Geigy; and DEN432 and DEN438 from Dow Chemical. These epoxide resins display good chemical resistance. These and other epoxy resins may be used in conjunction with various cross-linkers and/or additives described herein. For example, the cross-linkers can be a moiety that includes a plurality of amino groups, thiol groups, hydroxyl groups or mixtures of such groups. Water-based epoxy resins are commercially available under the name Enducryl® from Epoxy Systems, Inc.

A4. Optionally, UV absorber(s). Exemplary UV absorbers include bis(1,2,2,6,6-pentamethyl-4-piperidyl) sebacate CAS 41556-26-7 =0.5-1.5% by weight. Another exemplary UV absorber is that branded and commercially available as “ HALS292” and is an equivalent: to Tinuvin 292 and CYASORB UV-3765, having a Chemical name: bis(1,2,2,6,6-pentamethyl-4-piperidinyl)-sebacate, and also 1-(methyl)-8-(1,2,2,6,6-pentamethyl-4-piperidinyl)-sebacate (CAS No.: 41556-26-7), having a molecular formula: C₃₀H₅₆N₂O₄, molecular weight: 508.75, and a chemical structure:

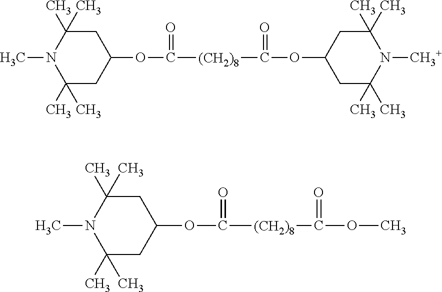

A5. Optionally, Silicon dioxide CAS 7631-86-9=0.5-1.5% by weight, and/or

A6. Optionally, Aluminum oxide CAS 1344-28-1 0.5-1.5% by weight.

Some examplary resin parts having at least a silicone base and an epoxy base are commercially available, such as those described in U.S. Pat. Nos. 5,618,860 and 5,275,645, the patents currently assigned to PPG Industries Ohio, Inc, which are incorporated herein by reference.

### B. Cure Part: The Cure Part Includes a Silane Base:

B1. Silane base =about 60-99% by weight. For example, U.S. Pat. No. 5,618,860 describes appropriate silane bases, including the preference for a organooxysilane and a difunctional aminosilane hardener component. As described in that patent, preferred organooxysilanes are trialkoxysilanes such as Union Carbide's A-163 (methyl trimethoxy silane), A-162, and A-137 and Dow Corning's Z6070 and Z6124. The hardener component comprises an amine chosen from the general classes of aliphatic amines, aliphatic amine adducts, polyamidoamines, cycloaliphatic amines and cycloaliphatic amine adducts, and aromatic amines. Preferred aminosilanes include, but are not limited to, aminoethyl aminopropyl triethoxysilane, n-phenylaminopropyl trimethoxysilane, trimethoxysilylpropyl diethylene triamine, 3-(3-aminophenoxy)propyl trimethoxy silane, amino ethyl amino methyl phenyl trimethoxy silane, 2 amino ethyl 3 aminopropyl, tris 2 ethyl hexoxysilane, n-aminohexyl aminopropyl trimethoxysilane and trisaminopropyl trismethoxy ethoxy silane.

The manufacturers and trade names of some aminosilanes useful in the present invention are Dow Corning Z6020, XI-6100, XI6150; Union Carbide A1100, A1101, A1102, A1108, A1110, A1120 A1126, A1130, A1387, Y9632; Wacker ED117 HSI A0696, A0698, A0699, A0700, A0710, A0720, A0733, A0733, A0742, A0750, A0800; and PCR 12328-1. The preferred polyamines and aminosilanes are aliphatic amines, methylene bis dianiline, diethyltoluene diamine, methylene bis diethylaniline, methylene bis diisopropylaniline, Versamine 170, and 6710E from Henkel located in Ambler, Pa., Ciba Geigy's XUHY350, XUHY310, and XUHY315, Pacific Anchor's Ancamine 2264, 2280, and 2168, NC541 from Cardolite located in Newark, N.J., Euredur 3265 and 3266 from Schering Berlin located in Dublin, Ohio, Huls' A0698, and 12328-1 from PCR located in Gainsville, Fla. Further, as described in Example 1 of U.S. Pat. No. 5,275,645 (hereby incorporated by reference), a silane base can include a silicone intermediate A such as Dow Corning 3074 resin (dimethylphenyltrimethoxysilane), a silicone intermediate B such as Dow Corning Resin Z 6018 (silanol terminated dipropylphenylpolysiloxane with an average molecular weight of about 1600), and a trialkoxysilane such as Union Carbide Silane A-163 (methyl trimethoxysilane).

B2. Catalyst =0.01-5% by weight. An exemplary catalyst is triethylamine , from Sigma Aldrich or Dabco T-12 from Air Products.

B3. Siloxane additive part: And the balance of the cure part (whether integrated with the sure or kept as a separate part) being a siloxane additive part. For example, about 0.1 to about 10% by weight of a siloxane additive part similar to that in Table 2 is added to the resin side.

In another example, the cure is made up of: Silane base=about 60-98%; and dibutyltin diacetylacetonate CAS 22673-19-4 (catalyst)=3-7%; and Tin, dibutylbis CAS 22673-19-4=0.01-5%.

TABLE 2
Siloxane additive part of Example 1

| | | | 172F1 (% by |
|---|---|---|---|
| Material | Tradename | Manufacturer | Weight) |
| Solvent | Isopropanol | | 20-40 |
| Solvent | Acetone | | 0-40 |
| Solvent | Water | | 0-5 |
| Solvent | Hexane | Ashland | 0-40 |
| Reactive PDMS | 3-0133 | Dow Corning | 0-20 |
| Methyl trimethoxy siloxane | Z-6070 | Dow Corning | 0-20 |
| Aminopropyl ethoxysilane | Z-6011 | Dow Corning | 0-20 |
| Phenyl trimethoxysilane | Z-6124 | Dow Corning | 0-20 |
| Catalyst | triethylamine | Sigma Aldrich | 0-5 |
| | Dabco T-12 | Air Products | 0-5 |

### Example 2

Below is a second exemplary siloxane additive part in accordance with the formulations herein. Preferably, the siloxane additive part is between about 0.01-5% of the final formulation, or the final cure part, or the final resin part. Preferably, of this cure part example, Formula 6-94A1 is between about 40 to about 60% and Formula 6-94B1 is between about 40 to about 60%. In one example, this siloxane additive part is added to the resin side at about 0.1-5% by weight. For example, the additive part is added to a resin that includes silicone base of about 15-40% by weight; titanium dioxide CAS 13463-67-7 of about 15-40% by weight; an epoxy base of about 10-30% by weight; bis(1,2,2,6,6-pentamethyl-4-piperidyl) sebacate CAS 41556-26-7 of about 0.5-1.5% by weight; silicon dioxide CAS 7631-86-9 of about 0.5-1.5% by weight; and aluminium oxide CAS 1344-28-1 of about 0.5-1.5% by weight. Preferably, the siloxane additive part is added to the resin before packaging the resin part. Once the user is ready to make the coating formulation, the resin part having the siloxane additive part therein is mixed with the cure part. The resulting coating composition is then applied to a substrate and allowed to cure to form a hard coating, such as a whiteboard.

TABLE 3
Siloxane additive part of Example 2

| | | 0-5% of | | |
|---|---|---|---|---|
| Material | Tradename | formula | 6-94A1 | 6-94B1 |
| 6-94A1 | | 40-60% | | |
| 6-94B1 | | 40-60% | | |
| Solvent | Isopropanol | | 80-90 | |
| Solvent | Acetone | | | 30-40 |
| Solvent | Water | | | 0-10 |
| Solvent | Hexane | | | 30-40 |
| Reactive PDMS | | | | 10-20 |
| Aminopropyl | | | 0-10 | |
| ethoxysilane | | | | |
| Catalyst | triethylamine | | 0-10 | |
| | dibutyltin dilaurate | | | 0-10 |
| | | 100 | 100 | 100 |

### Example 3

In yet another exemplary embodiment, the siloxane additive part of the formulation, identified as 6-60A2 in Table 4 below, includes:

TABLE 4
Siloxane additive part of Example 3

| Material | Tradename | 6-60A2 |
|---|---|---|
| 6-94A1 | | |
| 6-94B1 | | |
| Solvent | Isopropanol | 80-90 |
| Methyl trimethoxy siloxane | | 10-20 |
| Phenyl trimethoxysilane | | 0-5 |
| Catalyst | triethylamine | 0-5 |

### Example 4

In still another exemplary embodiment, the siloxane additive part of the cure part of the formulation includes:

TABLE 5
Siloxane additive part alternatives

| Material | Tradename | % |
|---|---|---|
| Solvent | Isopropanol | 30-40% |
| Solvent | Acetone | 20-30% |
| Solvent | Hexane | 20-30% |
| Reactive PDMS 0 | | 0-10% |
| Methyl trimethoxy siloxane | | 0-10% |
| Aminopropyl ethoxysilane | | 0-10% |
| Phenyl trimethoxysilane | | 0-10% |
| Catalyst | Triethylamine | 0-10% |
| Catalyst | Dibutylin dilaurate | 0-10% |

The components described in Tables 2-5 above can be mixed, following a procedure similar to that described in Example 1, to obtain a silane-based siloxane additive part containing the components having the weight percentage ranges indicated in the tables. This siloxane additive part is preferably mixed to form between about 0.1 to about 5% by weight of the resin part. However, any or all of the resin part, cure part, and siloxane additive part can be packaged together or apart to create one-component system or as part of a two or even three component system.

### Application of the Coating

The application is performed in a clean, dustless environment. Prior to installation, the ambient temperature within the application site is maintained at no less than 45° F. for a minimum of 24 hours and proper ventilation of application areas is ascertained to minimize odors in vicinity of application. The surface is painted in approximately 2 foot wide sections by working from one end to the other. Each section is completed before painting the next section. A wet edge is maintained to avoid lap marks. A single coat is applied using short nap roller cover. The equipment is cleaned with acetone or denatured alcohol. The coating is typically allowed to cure for 24-48 hours at room temperature to form the writable-erasable surface.

The writable-erasable surface can be maintained by daily erasure and cleaning with a standard dry-erase eraser or a dry cloth. For periodic and more thorough cleaning, a damp cloth may be used.

If it is desired to strip off the writable-erasable surface or recoat any damaged surface, the original surface is cleaned before application of the dry erase coating.

### Other Embodiments

A number of embodiments have been described. Nevertheless, it will be understood that various modifications can be made without departing from the spirit and scope of the disclosure. Accordingly, other embodiments are within the scope of the following claims.

For example, while rollers have been described for applying the materials, brushes, pre-loaded applicators, or sprayers can be used. When sprayers are used, the precursor materials can be first mixed and then sprayed onto a substrate, or the precursors materials can each be sprayed from separate nozzle outlet, the mixing of the precursors occurring in flight toward the substrate and/or on the substrate.

While whiteboards and coated walls have been described, the coatings can be applied to other forms. For example, any of the materials described herein can be applied to a continuous sheet of material, such as paper, to provide a product that includes a substrate and a coating extending upon the substrate.

Other solvent-based materials may be used alone, or in combination with other solvent-based materials described herein such as polyurethane materials.

The first and second components can be applied to the substrate, e.g., by concurrently spraying the components so that they mix in flight and/or on the substrate and then optionally applying a cross-linking promoter, such as an acid, to the mixed first and second components, e.g., in the form of a solution. In still other embodiments, a cross-linking promoter is first applied to the substrate and then the first and second components are applied to the substrate having the cross-linking promoter.

The first and second components can be mixed, e.g., by alternately adding the desired, pre-determined quantities of the components from a large drum to a paint bucket, mixing, and then applying the coating on a substrate. The advantage of this method is that the pot life of the components are preserved without wasting the components.

Still other embodiments are within the scope of the following claims.

1. A writable-erasable product comprising:
a cured coating extending upon a substrate and having a writable-erasable surface, the coating being curable under ambient conditions and being formed from one or more materials comprising one or more of a resin part and a cure part, wherein the resin part includes at least one silicone, at least one epoxy base having at least one epoxy-modified polysiloxane polymer, and wherein the cure part includes at least one silane and at least one of an accelerator or catalyst; wherein, after the writable-erasable surface is marked with a marking material comprising a colorant and a solvent, the marking material can be erased from the writable-erasable surface to be effectively invisible.

2. A composition for application to a substrate to form a writable-erasable coating surface, the composition comprising one or more materials comprising one or more of a resin part and a cure part, wherein the resin part includes at least one silicone, at least one epoxy base having at least one epoxy-modified polysiloxane polymer, and wherein the cure part includes at least one silane and at least one of an accelerator or catalyst, and wherein the composition is substantially solventless.

3. A method of forming a writable-erasable product, the method comprising the steps of applying a composition of claim 2 to a substrate to form a smooth coating that cures to provide a writable-erasable surface.

4. A siloxane additive part for use in combination with a resin part and a cure part to form a coating composition for application to a substrate, wherein:
the siloxane additive part comprises at least one siloxane;
the resin part includes at least one epoxy-modified polysiloxane polymer base and at least one silicone base;
the cure part includes at least one silane; and
wherein the coating composition cures upon application to a substrate to form a writable-erasable surface.

5. The additive part of claim 4, wherein the additive part comprises a siloxane selected from the group consisting of methyl trimethyl siloxane, methyl trimethoxy siloxane, polydimethylsiloxane, and combinations thereof.

6. The additive part of claim 4, wherein the additive part further comprises at least one silane.

7. The additive part of claim 6, wherein the at least one silane is selected from the group consisting of aminopropyl ethoxysilane, phenyl trimethoxysilane, and combinations thereof.

8. The additive part of claim 4, further comprising at least one catalyst.

9. The additive part of claim 8, wherein the at least one catalyst is selected from the group consisting of thiethylamine, dubutylin dilurate, and combinations thereof

10. The additive of claim 4, further comprising at least one solvent, the solvent selected from the group consisting of isopropanol, acetone, hexane, and combinations thereof
